(19) United States
(12) Patent Application Publication
(10) Pub. No.: US 2014/0092725 A1
(43) Pub. Date: Apr. 3, 2014

(54) METHOD AND FIRST NETWORK NODE FOR MANAGING AN ETHERNET NETWORK

(71) Applicant: Telefonaktiebolaget L M Ericsson (publ), Stockholm (SE)

(72) Inventor: Johan Lindström, Hägersten (SE)

(73) Assignee: Telefonaktiebolaget L M Ericsson (publ), Stockholm (SE)

(21) Appl. No.: 13/995,041

(22) PCT Filed: May 20, 2013
(86) PCT No.: PCT/SE2013/050566

§ 371 Date: Jun. 17, 2013

Related U.S. Application Data
(60) Provisional application No. 61/649,424, filed on May 21, 2012.

(51) Int. Cl. H04L 12/24

(52) U.S. Cl. CPC H04L 41/0654
USPC 370/221

(57) ABSTRACT

A method and a first network node for managing an Ethernet network are disclosed. The Ethernet network comprises the first network node, a second network node and a third network node. The Ethernet network is configured as a Spanning Tree Protocol domain, STP domain. A first root is serving the STP domain. The first network node detects a failure of the first root. Then, the first network node sends a respective first frame indicating a second root to serve the STP domain. The first network node receives, from the second network node, a second frame indicating access to the first root via the third network node. Next, the first network node discards the second frame indicating access to the first root.

### TECHNICAL FIELD

Embodiments herein relate to communication networks, such as Ethernet networks. A method and a first network node for managing Ethernet networks are disclosed.

### BACKGROUND

In a switched Ethernet, it is desired to avoid transmission loops since the network would collapse if frames are sent in loops and a feature of self learning addressing deteriorates. Examples of loops in a switched Ethernet are illustrated in FIG. 1.

However, if switches in a switched Ethernet can not be connected to create loops, there can never be any redundancy in the network. There are two major techniques for providing redundancy while avoiding transmission loops referred to as link aggregation and Spanning Tree Protocol (STP).

Link aggregation, such as defined in specification 802.3 2005 from Institute of Electrical and Electronics Engineers (IEEE 802.3 2005), is a method to achieve higher bandwidth and/or redundancy in Ethernet networks. Two or more physical links are combined and treated as one physical link. Hence, a number of the physical links will be treated as one Link Aggregation Group (LAG) as illustrated in FIG. 2.

There are different Spanning Tree Protocol modes, defined in STP IEEE 802.1d, e.g. Rapid Spanning Tree Protocol (RSTP) IEEE 802.1d and Multiple Spanning Tree Protocol IEEE 802.1q. The principle of the STP is that one of the Ethernet Switches is elected as a root switch in the network, and in the spanning tree every switch has exactly one way to reach the root switch. All other Ethernet switches calculate their pathcost to reach the root switch. The cheapest pathcost is opened, and all other links are blocked for traffic as illustrated in FIG. 3. RSTP allows redundancy in an Ethernet Local Area Network (LAN) by disabling some selected ports so no loops are created.

In all STP modes the pathcost is used to calculate the cheapest way to reach the root. The pathcost is either fixed or based on the bandwidth available on the physical link. When a physical link between two switches is replaced by a LAG, the bandwidth and cost may vary dependent on the number of operating physical links The pathcost is calculated automatically according to the following formula: Pathcost=20 000 000 000 000/Bandwidth

This implies that a bandwidth of 1 Gbit/second gives the pathcost 20000.

An additional technique used for STP is to use Layer 2 Gateway Port (L2GP) defined in IEEE 802.1ah 2008. This technique is used to separate different STP domains. One or more ports are elected as Layer 2 Gateway Ports (L2GPs), which will define the border of a domain in which the STP algorithm is active. Only one L2GP, at any given time, will be open towards another STP domain, i.e. the port with the best root identity, i.e. priority and MAC address. A pseudo root switch is emulated outside the own STP domain. L2GP, as mentioned above, is a dedicated port in a RSTP network that is separating the RSTP domain from other layer 2 networks (Ethernet Networks). This is illustrated in FIG. 4 where a L2GP in a first switch 41 in RSTP domain 1 has lower (better) priority than a L2GP in a second switch 42. This implies that the first switch 41 is open towards another RSTP domain, i.e. a RSTP domain 2 as illustrated in the Figure.

When the first switch 41 or the physical link where L2GP is configured goes down, any remaining physical loops may open all ports and create loops that results in that frames are caught in a loop. When a root is included in the domain, a solution to this problem is to always include the root in any loop of the domain.

However, when using L2GP, the root is not included in the RSTP domain and when an external link to an Ethernet Switch 51 goes down, all switches in RSTP domain 1 will experience that the root disappears. This is illustrated in FIG. 5. It takes a certain time period to update the network with a new root switch, such as a new pseudo root. During this time period, a problem known as “count-to-infinity” may create temporary loops in the RSTP domain 1, since some Ethernet switches has not yet received information about that the external link has gone down. Expressed differently, some Ethernet switches have old information which do not reflect a change of the root. Based on this old information, these Ethernet switches may decide to open paths such that temporary loops are created.

Bridge Protocol Data Unit (BPDU) is a frame sent between switches where RSTP information is exchanged between the switches.

Again referring to FIG. 5, two RSTP domains 1, 2 where the L2GP of Ethernet Switch 51 has gone down and the assigned pseudo root identity no longer is valid as root identity.

The pseudo root must therefore be changed to the pseudo root of Ethernet Switch 52. Since it take some time for the network to be updated with the new pseudo root, the RSTP domain 1 may create loops as a result of count-to-infinity problem as long as the network is not fully updated with the new pseudo root.

Hence, a problem is that count-to-infinity causes long convergence times together with a layer 2 gateway port. In order to reduce the time spent in a count-to-infinity loop, it has been proposed in US2012/0051266 to configure L2GPS in a first STP domain connected towards a second STP domain. US2013/0051266 proposes that a pathcost is added to the layer 2 gateway port and that all layer 2 gateway ports must use identical pseudoRootId. Although, US2012/0051266 discloses a satisfying method in terms of short convergence time, improvements may still be made. For example, a disadvantage with the method proposed in US2012/0051266 is that an operator of the system must configure additional attributes, such as a common pseudorootId and additional pathcosts. Further, a fact is that the method is not according to the IEEE standard since propriety handling of pseudoRootIds are required. Additionally, the method proposed in the above mentioned application requires configuration, such as configuration of the pathcosts, to be performed by the operator. The pathcosts may be very difficult to estimate for a real network. This need of configuration is contrary to the spirit of RSTP, which is self-configuration of the networks and that default values should be enough to ensure a fully functional network. A further disadvantage is that one so called count to infinity loop will be allowed. Thereby, long convergence time is still unnecessarily lengthy.

### SUMMARY

An object is how to overcome, or at least alleviate, the above mentioned disadvantages. In particular, an object may be how to improve, e.g. reduce, convergence time in an Ethernet network configured as an STP domain.

According to an aspect, this object is achieved by a method in a first network node for managing an Ethernet network. The Ethernet network comprises the first network node, a second network node and a third network node. The Ethernet network is configured as a STP domain. A first root is associated with the first network node. The first root is serving the STP domain. The first network node detects a failure of the first root. The first network node sends, to each of the second and third network nodes, a respective first frame indicating a second root to serve the STP domain. The first network node receives, from the second network node, a second frame indicating access to the first root via the third network node. The first network node discards the second frame indicating access to the first root.

According to another aspect, this object is achieved by a first network node configured to manage an Ethernet network. The Ethernet network comprises the first network node, a second network node and a third network node. The Ethernet network is configured as a STP domain. A first root is associated with the first network node. The first root is serving the STP domain. The first network node comprises a processing circuit configured to detect a failure of the first root; and to send, to each of the second and third network nodes, a respective first frame indicating a second root to serve the STP domain. Moreover, the processing circuit is configured to receive, from the second network node, a second frame indicating access to the first root via the third network node, and to discard the second frame indicating access to the first root.

Since the first network node detects that the first root has failed, it is able to know that the received second frame, indicating access to the first root, is not correct. Thus, the first network node discards the second frame. According to prior art, the second frame, or the information carried by the second frame, would have been forwarded to the third network node. Thereby, the so called count-to-infinity loop is effectively kept alive. However, according to the embodiments herein, the second frame is discarded. As a result, the count-to-infinity loop is broken.

According to embodiments herein, an improvement within the known IEEE standard is achieved. The embodiments herein are, of course, not described by the known standard.

In order to implement the embodiments herein, a code modification may be enough to improve the characteristics of a RSTP network. This modification will not be visible to a user, unless equipment to listen to configuration messages sent on the bridge ports is used. The user will instead notice an improved characteristics, in terms of shorter convergence time as compared to prior art.

With the embodiments herein, no advanced configuration is required to achieve the improved, in terms of for example shorter or good, convergence times at link failure. The link failure may relate to the failure of the root.

In some embodiments herein, all L2GP ports may have unique so called pseudoRootIds as configured according to known techniques. The expression “pseudoRootId” is known from for example IEEE 802.1ah.

With some embodiments herein, the first network node, such as a bridge that has L2GP defined, inspects incoming frames, such as BPDUs, and if the RootId in the BPDU is identical to the pseudoRootId stored on the L2GP that that the first network node owns, i.e. has configured, the first network node will break the count to infinity loop by not transmitting BPDU information onwards in the loop, i.e. discarding the BPDU information. The second frame, e.g. an incoming BPDU, can either be discarded or be replied to with a BPDU that helps to resolve the loop.

### BRIEF DESCRIPTION OF THE DRAWINGS

The various aspects of embodiments disclosed herein, including particular features and advantages thereof, will be readily understood from the following detailed description and the accompanying drawings, in which:

FIG. 1 is a schematic block diagram illustrating Ethernet networks according to prior art,

FIG. 2 is a schematic block diagram illustrating Ethernet networks, in which Link Aggregation has been implemented, according to prior art,

FIG. 3 is a schematic block diagram illustrating Ethernet networks, in which Spanning Tree has been implemented, according to prior art,

FIG. 4 is a schematic block diagram illustrating Ethernet networks, in which Spanning Tree has been implemented, according to prior art,

FIG. 5 is a schematic block diagram illustrating Ethernet networks, in which Spanning Tree has been implemented, according to prior art,

FIG. 6 is a schematic block diagram illustrating an exemplifying network according to embodiments herein,

FIG. 7 is a combined signaling scheme and flowchart illustrating embodiments herein,

FIG. 8 is a schematic block diagram illustrating embodiments herein,

FIG. 9 is a flowchart illustrating embodiments of the method in the first network node,

FIG. 10 is another block diagram illustrating embodiments of the first network node, and

FIG. 11 is a further schematic block diagram illustrating embodiments herein.

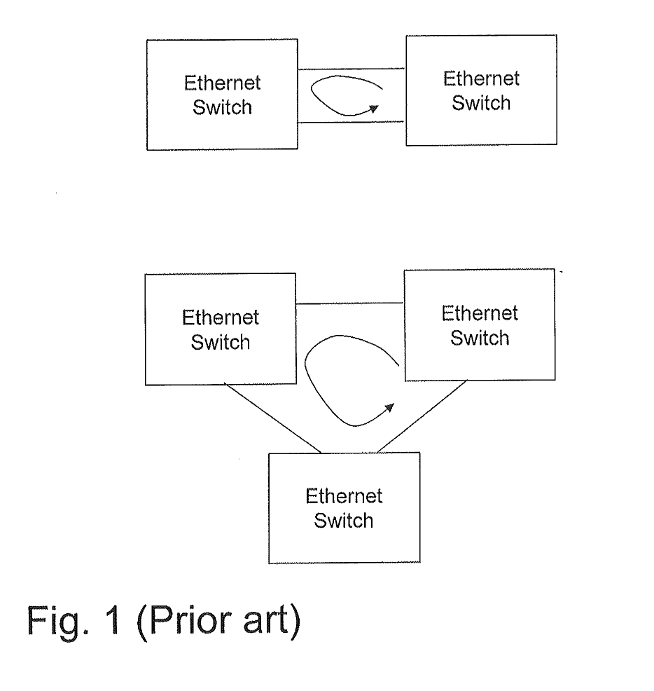

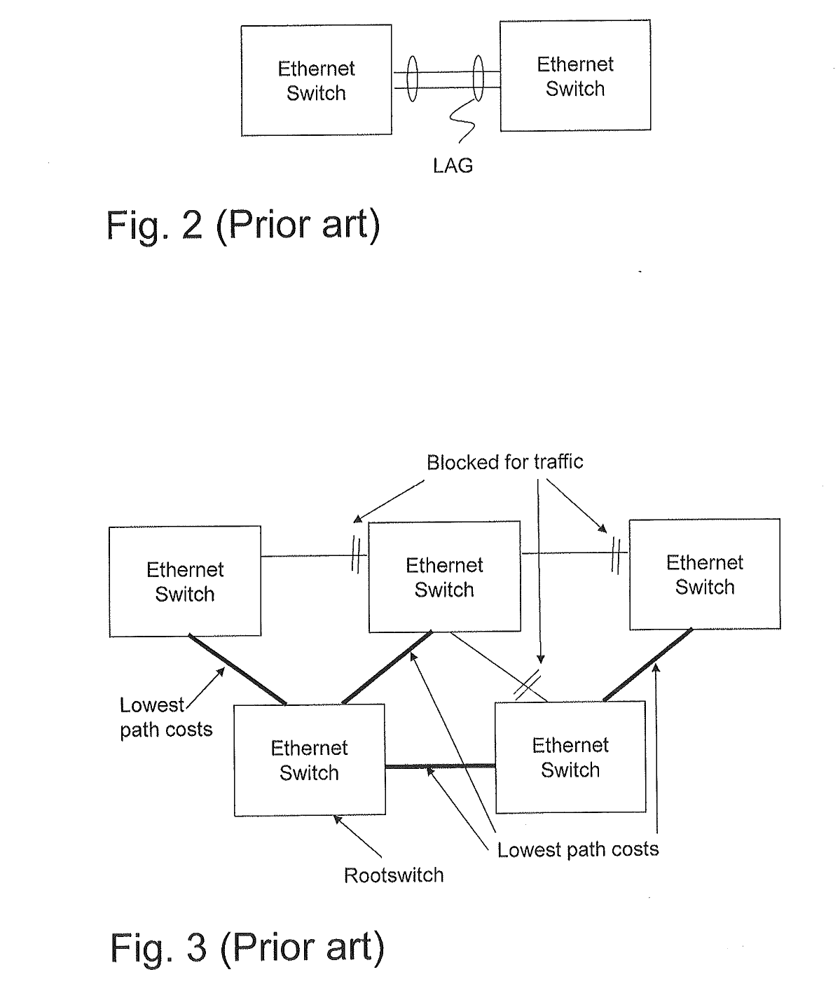

### DETAILED DESCRIPTION

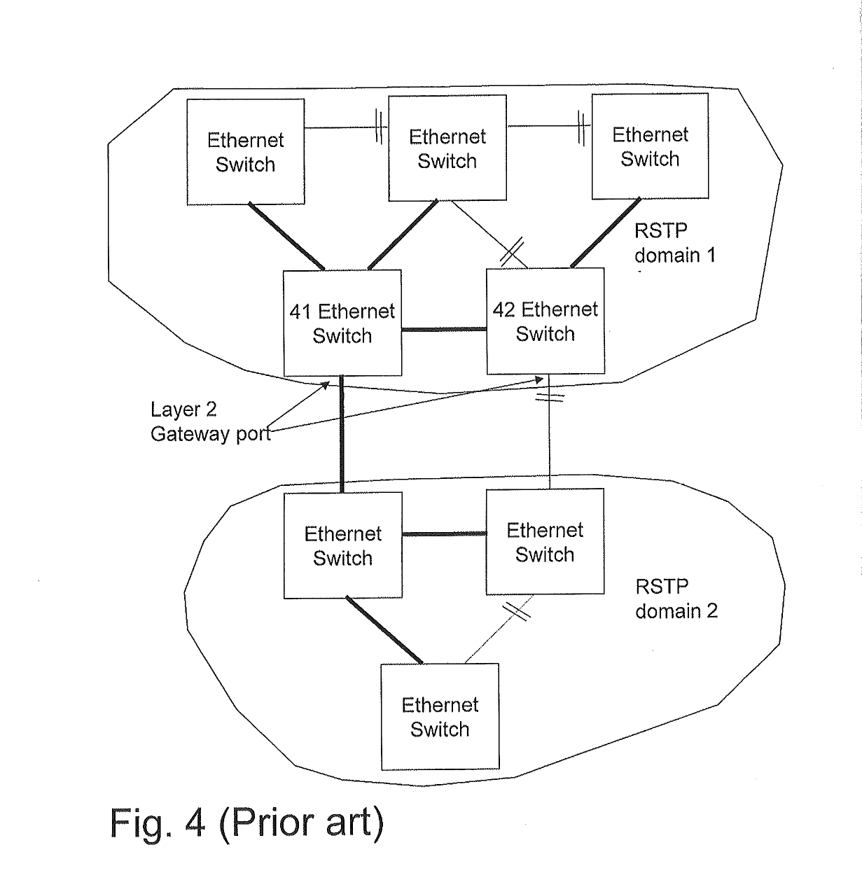

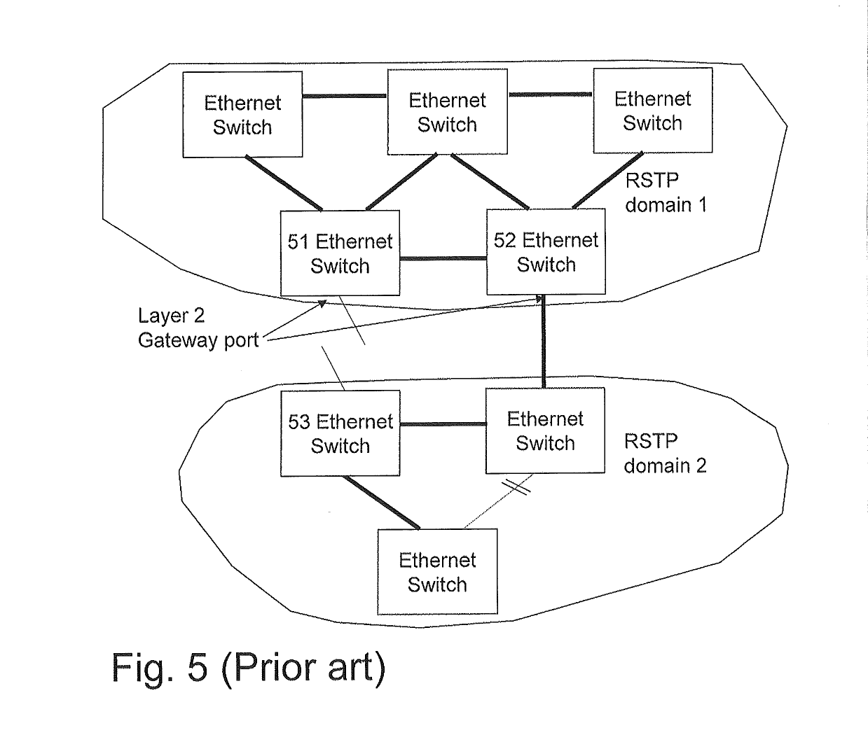

Returning to the discussion in the background section, a problem may occur when the port with best L2GP Pseudorootid goes to PHYsical (PHY) down. The best L2GP Pseudorootide may be best in terms of MAC address and/or priority. Since the network of the kind illustrated in for example FIG. 4 has a memory of this pseudorootId, it will be searched for in several loops in the network. Therefore, the embodiment herein proposes a method to achieve fast convergence times in a spanning tree domain when L2GP is lost.

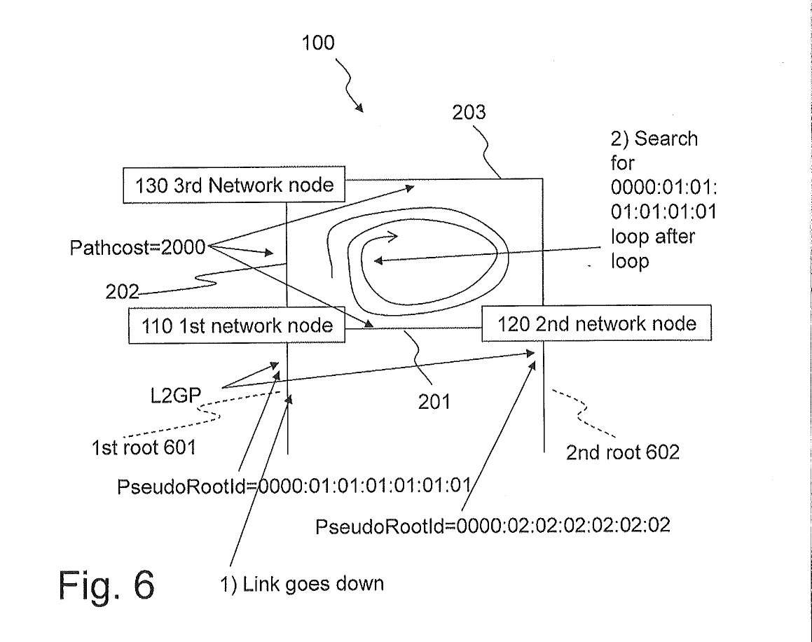

FIG. 6 shows an exemplifying network, such as an Ethernet network 100, in which embodiments herein may be implemented.

The Ethernet network 100 comprises a first network node 110, a second network node 120 and a third network node 130. The first network node 110 may be a first Ethernet switch, the second network node 120 may be a second Ethernet switch, and/or the third network node 130 may be a third Ethernet switch. The Ethernet network 100 is configured as a STP domain. A first root is associated with the first network node 110. The first root is serving the STP domain.

In this example, the first root is a pseudo root located outside the STP domain. As an example, the first root is a virtual switch identified by a so called pseudoRootId. Moreover, in this example, a port of the first network node 110 is associated to the first root. The port may be defined as a Layer 2 Gateway Port, L2GP.

During configuration, see also action 701 and 702 below, the pathcosts for the paths 201, 202 and 203 are set.

Briefly, when operating the Ethernet network 100, the following events occur. A link L1 with pseudorootId 0000:01:01:01:01:01:01 is broken. This information is sent to both the second and third network nodes 120, 130, such as a Bridge B and a Bridge D, but due to count to infinity problem there is a risk high risk that the first network node 110, such as a Bridge A, will receive a BPDU from the second or third network node 120, 130 that the PseudoRootId 0000:01:01:01:01:01:01 can be reached at with cost 6000, i.e. sum of 2000 and 2000 and 2000.

In the Figure, it is the second network node 120 that claims it can reach 0000:01:01:01:01:01:01 at the cost of 4000. The first network node 110 adds 2000 which is the cost from the second network node 120 to the first network node 110.

According to embodiments herein, the first network node 110 is able to know that 0000:01:01:01:01:01:01 is down since the first network node 110 owns this L2GP. The first network node 110 should not tell the third network node 130 that the third network node 130 can reach the pseudo root at the cost of 8000. It should just drop this BPDU and wait for a clean-up BPDU that will arrive from the second network node 120 with an existing RootId. The first network node 110 should close the port towards the third network node 130 while it waits for a clean-up message, such as a cleanupBPDU frame.

In above brief description of the operation, a first root 601 is associated to a port of the first network node 110 and a second root is associated to a port of the second network node 120.

As an alternative to wait for a cleanup message, the first network node 110 may suggest itself as a root and send that as a proposal to the second and/or third network nodes 120, 130.

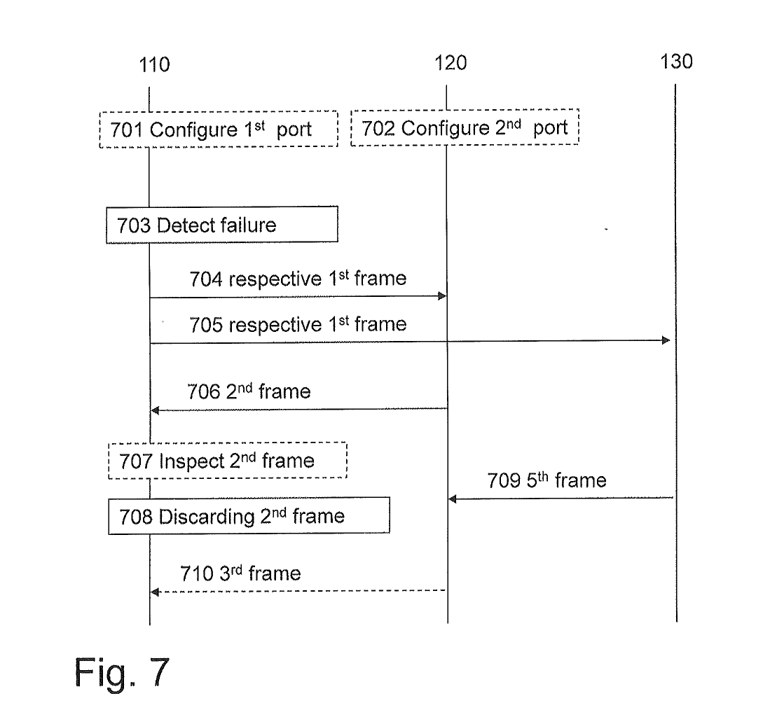

FIG. 7 illustrates an exemplifying method in, i.e. performed by, the first network node 110 for managing the Ethernet network 100 of FIG. 6.

The following actions may be performed by the first network node 110—in any suitable order.

### Action 701

The first network node 110 may configure the port of the first network node 110 to be associated with the first root 601. For example as in prior art, this may be done by setting a property of the port of the first network node 110 to L2GP and by setting a low number of a priority for the port. A low number of the priority gives the port a high priority. Typically, an operator manages the first network node 110 to configure the port to be associated with the first root 601.

### Action 702

The second network node 120 may configure the port of the second network node 120 to be associated with the second root 602. Similarly to action 701, a property of the port of the second network node 120 may be set to L2GP and a priority for the port may be set to a low number.

### Action 703

The first network node 110 detects a failure of the first root. For example, the first network node 110 may detect the failure by reading PHY down at the port, i.e. an L2GP port, of the first network node 110. In this manner, the first network node 110 is made aware of that the first root has failed, or malfunctions in some way.

### Action 704

The first network node 110 sends, to each of the second and third network nodes 120, 130, a respective first frame indicating a second root to serve the STP domain;

### Action 705

The first network node 110 sends, to each of the second and third network nodes 120, 130, a respective first frame indicating a second root to serve the STP domain.

Implicitly action 704 and 705 mean that the first root has failed. In some examples, actions 704 and 705 are performed as one single action. The respective first frames may comprise a respective first Bridge Protocol Data Unit, BPDU, frame.

### Action 706

In order for the first network node 110 to be informed about alternative-paths to reach the first root, the first network node 110 receives, from the second network node 120, a second frame indicating access to the first root via the third network node 130. The second frame may comprise a second BPDU frame.

However, since the first network node detected in action 703 that the first root has failed, the first network node 110 is able to know that the received second frame, indicating access to the first root, is not correct. A reason to that the second network node 120 sends the erroneous second frame is that the second network node has not yet received a frame from the third network node 130 about that the first root is lost also for path 203.

### Action 707

The first network node 110 may inspect the second frame in order to determine whether or not to discard the second frame in action 708. This action 707 may be performed before or after generation of a frame to be forwarded to the third network node 130, e.g. before or after processing of the second frame according to known techniques. This means that the inspection may be performed at reception of the second frame, just before transmission of the generated frame or at any occasion therebetween. At any rate, the inspection is preferably performed before transmission of the generated frame, which includes at least some erroneous information from the second frame.

### Action 708

The first network node 110 discards the second frame indicating access to the first root. In this manner, the first network node 110 manages the Ethernet network 100 by handling the failure of the first root in that the second frame is discarded.

Thus, the first network node 110 breaks the count to infinity “chain” based on that the first network node knows that the port associated to the first root is “down”.

In case the first network node 110 has not detected a failure of the first root in action 703, the first network node 110 does not discard the second frame. Instead, the second frame is forwarded to for example the third network node 130.

### Action 709

As mentioned in action 706, the second network node 120 had, at the time of the action 706, not yet received information about that the first root had failed. However, in this action 709, the information about that the first root has failed catches up to the second network node 120. Thus, the second network node 120 may receive a fifth frame from the third network node 130. The fifth frame may indicate that the second root is to serve the Ethernet network, whereby it is implicitly signaled that the first root has failed.

### Action 710

The first network node 110 may receive, from the second network node 120 a third frame indicating the second root to serve the STP domain. The third frame may comprise a third BPDU frame. In this manner, the information about the failure has passed through the loop of the second and third network nodes 120, 130. This means that all nodes in this example have been informed about the failure of the first root.

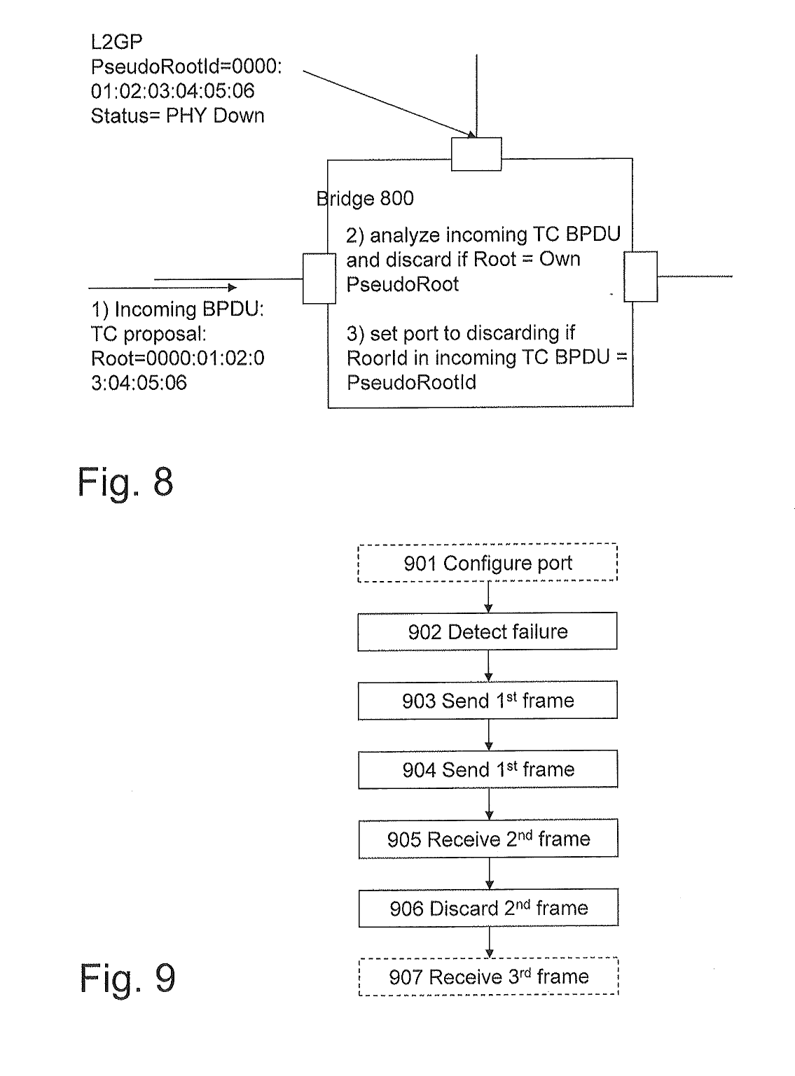

FIG. 8 illustrates a further exemplifying embodiment. In this embodiment the following actions may be performed.

1) An incoming BPDU, as an example of the first frame, is received at the bridge 800, as an example of the first network node 110. The incoming BPDU indicates a Topology Change (TC), such as a proposal of a root.

2) The bridge 800 analyses the incoming BPDU and discards it if root indicated in the incoming BPDU is equal to a PseudoRoot of the bridge 800.

3) The bridge 800 sets port to discarding if RootId in the incoming BPDU is equal to the PseudoRoot of the bridge 800.

FIG. 9 illustrates an exemplifying method in the first network node 110 for managing an Ethernet network 100. As mentioned, the Ethernet network 100 comprises the first network node 110, a second network node 120 and a third network node 130. The first network node 110 may be a first Ethernet switch, the second network node 120 may be a second Ethernet switch, and/or the third network node 130 may be a third Ethernet switch. The Ethernet network 100 is configured as a STP domain. A first root is associated with the first network node 110. The first root is serving the STP domain.

Also in this example, the first root is a pseudo root located outside the STP domain. Moreover, in this example, a port of the first network node 110 is associated to the first root. The port may be defined as a Layer 2 Gateway Port, L2GP.

The following actions may be performed in any suitable order.

### Action 901

The first network node 110 may configure the port of the first network node 110 to be associated with the first root. This action is similar to action 701.

### Action 902

The first network node 110 detects a failure of the first root. The detecting of the failure of the first root may comprise reading Physical, PHY, down at the port. This action is similar to action 703.

### Action 903

The first network node 110 sends, to each of the second and third network nodes 120, 130, a respective first frame indicating a second root to serve the STP domain. This action is similar to action 704.

### Action 904

The first network node 110 sends, to each of the second and third network nodes 120, 130, a respective first frame indicating a second root to serve the STP domain. This action is similar to action 705. The respective first frames may comprise a respective first Bridge Protocol Data Unit, BPDU, frame.

### Action 905

The first network node 110 receives, from the second network node 120, a second frame indicating access to the first root via the third network node 130. The second frame may comprise a second BPDU frame. This action is similar to action 706.

### Action 906

The first network node 110 discards the second frame indicating access to the first root. This action is similar to action 708.

### Action 907

The first network node 110 may receive, from the second network node 120 a third frame indicating the second root to serve the STP domain. The third frame may comprise a third BPDU frame. This action is similar to action 710.

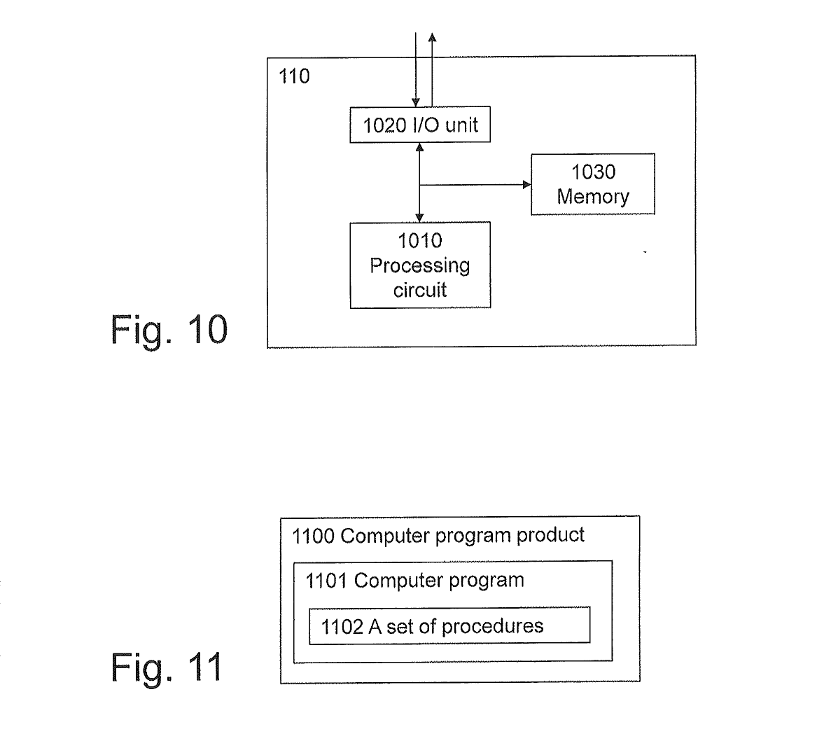

With reference to FIG. 10, a schematic block diagram of the first network node 110 is shown. The first network node 110 is configured to manage the Ethernet network 100 of FIG. 6 as described with reference to FIGS. 7 and 9. As mentioned above; the Ethernet network 100 comprises the first network node 110, a second network node 120 and a third network node 130. The first network node 110 may be a first Ethernet switch, the second network node 120 may be a second Ethernet switch, and/or the third network node 130 may be a third Ethernet switch. The Ethernet network 100 is configured as a STP domain. A first root is associated with the first network node 110. The first root is serving the STP domain.

Again in this example, the first root is a pseudo root located outside the STP domain. Moreover, in this example, a port of the first network node 110 is associated to the first root. The port may be defined as a Layer 2 Gateway Port, L2GP.

The first network node 110 comprises a processing circuit 1010 configured to detect a failure of the first root. The processing circuit 1010 may be configured to detect the failure of the first root by reading Physical, PHY, down at the port.

The processing circuit 1010 is configured to send, to each of the second and third network nodes 120, 130, a respective first frame indicating a second root to serve the STP domain. The respective first frames may comprise a respective first Bridge Protocol Data Unit, BPDU, frame.

The processing circuit 1010 is configured to receive, from the second network node 120, a second frame indicating access to the first root via the third network node 130. The second frame may comprise a second BPDU frame.

The processing circuit 1010 is configured to discard the second frame indicating access to the first root.

The processing circuit 1010 may further be configured to receive, from the second network node 120 a third frame indicating the second root to serve the STP domain. The third frame may comprise a third BPDU frame.

The processing circuit 1010 may further be configured to configure the port of the first network node 110 to be associated with the first root.

The processing circuit 1010 may be a processing unit, a processor, an application specific integrated circuit (ASIC), a field-programmable gate array (FPGA) or the like. As an example, a processor, an ASIC, an FPGA or the like may comprise one or more processor kernels.

The first network node 110 may further comprise an Input/Output (I/O) unit 1020, which may be configured to send and/or one or more numbers, values or parameters described herein.

The first network node 110 may further comprise a memory 1030 for storing software to be executed by, for example, the processing circuit 1010. The software may comprise instructions to enable the processing circuit to perform the method in the first network node 110 as described above in conjunction with FIG. 7 and/or 9. The memory may be a hard disk, a magnetic storage medium, a portable computer diskette or disc, flash memory, random access memory (RAM), a portable memory for insertion into a host device, or the like. Furthermore, the memory may be an internal register memory of a processor.

Embodiments of the present invention may include computer-readable instructions stored on non-transitory computer readable storage medium, wherein at least one processor executes the computer-readable instructions to implement the methods described herein. Also, the elements described herein (e.g., Ethernet switch, bridge, etc.) can be implemented as at least one processor coupled to a non-transitory computer-readable storage medium. The at least one processor executes computer-readable instructions stored on the non-transitory computer-readable storage medium to implement the methods described herein.

FIG. 11 illustrates an exemplifying computer program product 1100. The computer program product 11000 comprises a computer program 1101, which comprises a set of procedures 1102, stored on a computer readable medium, which procedures when run on or executed by the first network node 110 causes the first network node 110 to perform the action described in the foregoing in connection with FIG. 7 and/or 9. In more detail, the computer program 1101 is capable of detecting a failure of the first root; sending, to each of the second and third network nodes (120, 130), a respective first frame indicating a second root to serve the STP domain; receiving, from the second network node (120), a second frame indicating access to the first root via the third network node (130); and discarding the second frame indicating access to the first root.

In the foregoing description in conjunction with FIGS. 10 and 11, the memory 1030, the computer program product 1100 and the computer readable medium have the same or similar function. In some examples, one or more of these entities may be combined into one entity.

As used herein, the terms “number”, “value” may be any kind of digit, such as binary, real, imaginary or rational number or the like. Moreover, “number”, “value” may be one or more characters, such as a letter or a string of letters. “number”, “value” may also be represented by a bit string.

Even though embodiments of the various aspects have been described, many different alterations, modifications and the like thereof will become apparent for those skilled in the art. The described embodiments are therefore not intended to limit the scope of the present disclosure.

1. A method in a first network node for managing an Ethernet network, wherein the Ethernet network comprises the first network node, a second network node and a third network node, the Ethernet network being configured as a Spanning Tree Protocol, STP, domain, wherein a first root is associated with the first network node, and wherein the first root is serving the STP domain, the method comprising:
detecting a failure of the first root;
sending, to each of the second and third network nodes, a respective first frame indicating a second root to serve the STP domain;
receiving, from the second network node, a second frame indicating access to the first root via the third network node; and
discarding the second frame indicating access to the first root.

2. The method according to claim 1, further comprising:
receiving, from the second network node a third frame indicating the second root to serve the STP domain.

3. The method according to claim 1, wherein the respective first frame comprise a respective first Bridge Protocol Data Unit, BPDU, frame.

4. The method according to claim 1, wherein the second frame comprises a second BPDU frame.

5. The method according to claim 2, wherein the third frame comprises a third BPDU frame.

6. The method according to claim 1, wherein the first root is a pseudo root located outside the STP domain.

7. The method according to claim 1, wherein a port of the first network node is associated to the first root.

8. The method according to claim 7, wherein the detecting of the failure of the first root comprises reading Physical, PHY, down at the port.

9. The method according to claim 7, further comprising:
configuring the port of the first network node to be associated with the first root.

10. The method according to claim 7, wherein the port is defined as a Layer 2 Gateway Port, L2GP.

11. The method according to claim 1, wherein the first network node is a first Ethernet switch, the second network node is a second Ethernet switch, and/or the third network node is a third Ethernet switch.

12. A first network node configured to manage an Ethernet network, wherein the Ethernet network comprises the first network node, a second network node and a third network node, the Ethernet network being configured as a Spanning Tree Protocol, STP, domain, wherein a first root is associated with the first network node, and wherein the first root is serving the STP domain, wherein the first network node comprises a processing circuit configured to:
detect a failure of the first root;
send, to each of the second and third network nodes, a respective first frame indicating a second root to serve the STP domain;
receive, from the second network node, a second frame indicating access to the first root via the third network node; and
discard the second frame indicating access to the first root.

13. The first network node according to claim 12, wherein the processing circuit further is configured to receive, from the second network node a third frame indicating the second root to serve the STP domain.

14. The first network node according to claim 12, wherein the respective first frames comprise a respective first Bridge Protocol Data Unit, BPDU, frame.

15. The first network node according to claim 12, wherein the second frame comprises a second BPDU frame.

16. The first network node according to claim 13, wherein the third frame comprises a third BPDU frame.

17. The first network node according to claim 12, wherein the first root is a pseudo root located outside the STP domain.

18. The first network node according to claim 12, wherein a port of the first network node is associated to the first root.

19. The first network node according to claim 18, wherein the detecting of the failure of the first root comprises reading Physical, PHY, down at the port.

20. The first network node according to claim 18, wherein the processing circuit further is configured to configure the port of the first network node to be associated with the first root.

21. The first network node according to claim 18, wherein the port is defined as a Layer 2 Gateway Port, L2GP.

22. The first network node according to claim 12, wherein the first network node is a first Ethernet switch, the second network node is a second Ethernet switch, and/or the third network node is a third Ethernet switch.

23. A computer program for managing an Ethernet network, wherein the Ethernet network is configured to comprise the first network node, a second network node and a third network node, the Ethernet network being configurable as a Spanning Tree Protocol, STP, domain, wherein a first root is associable to the first network node, and wherein the first root is capable of serving the STP domain, wherein the computer program comprises computer readable code units which when executed by the first network node causes the first network node to:
detect a failure of the first root;
send, to each of the second and third network nodes, a respective first frame indicating a second root to serve the STP domain;
receive, from the second network node, a second frame indicating access to the first root via the third network node; and
discard the second frame indicating access to the first root.

24. A computer program product comprising a computer program according to claim 23, wherein the computer program is stored on the computer program product.
